(19) United States
(12) Patent Application Publication
(10) Pub. No.: US 2011/0216068 A1
(43) Pub. Date: Sep. 8, 2011

(54) Edge processing techniques

(76) Inventor: Rahul P. Sathe, Folsom, CA (US)

(21) Appl. No.: 12/660,956

(22) Filed: Mar. 8, 2010

(51) Int. Cl. G06T 11/20; G06T 1/20

(52) U.S. Cl. 345/441

(57) ABSTRACT

In some embodiments, an edge cache data table for edges shared by two or more geometrically contiguous patches is generated. An identification value is assigned for each patch. When a first patch has a common edge with a second patch, a unique identification value is generated for an entry in the table based on identification values of the two patches with a common edge. Attributes of a common edge are stored in the entry in the table associated with the unique identification value. When the common edge is to be evaluated for the second patch, the edge can be read from the table in reverse order.

### RELATED APPLICATIONS

This application is related to U.S. patent application having Ser. No. 12/347,114, entitled “A TESSELLATOR WHOSE TESSELLATION TIME GROWS LINEARLY WITH THE AMOUNT OF TESSELLATION,” filed Dec. 31, 2008 (attorney docket P29143), inventors Sathe and Rosen; Ser. No. 12/347,114, entitled “IMAGE FORMATION TECHNIQUES,” filed Apr. 29, 2009 (attorney docket P29929), inventors Sathe and Rosen; and PCT/US2009/069353, entitled “Image Processing Techniques,” filed Dec. 23, 2009 (attorney docket P31681)

### FIELD

The subject matter disclosed herein relates generally to graphics processing, and more particularly to processing edges of patches.

### RELATED ART

The graphics pipeline may be responsible for rendering graphics for games, computer animations, medical applications, and the like. Graphics processing pipelines, such as Microsoft® DirectX 11, increase the geometric detail by increasing tessellation detail. Tessellation is the formation of a series of triangles to render an image of an object starting with a coarse polygonal model. A patch is a basic unit at the coarse level describing a control cage for a surface. The patch may represent a curve or region and may be tangent to the object surface. The surface can be any surface that can be described as a parametric function. A control cage is a low resolution model used by artists to generate smooth surfaces. Thus, by providing a higher extent of tessellation, the level of graphical detail that can be depicted is greater. However, the processing speed may be adversely affected. It is desirable to increase the speed at which graphical detail can be provided for display.

### BRIEF DESCRIPTION OF THE DRAWINGS

Embodiments of the present invention are illustrated by way of example, and not by way of limitation, in the drawings and in which like reference numerals refer to similar elements.

FIG. 1 is a schematic depiction of a graphics pipeline in accordance with one embodiment.

FIG. 2 depicts a process that can be used to determine whether to store or retrieve attributes of a shared edge in a table.

FIG. 3 depicts a suitable system that can use embodiments of the invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Some embodiments provide for generating an edge cache data table for edges shared by two or more geometrically contiguous patches. An identification value is assigned for each patch. When a first patch has a common edge with a second patch, a unique identification value is generated for an entry in the table based on identification values of the two patches with a common edge. Attributes of a common edge are stored in the entry in the table associated with the unique identification value. When the common edge is to be evaluated for the second patch, the edge can be read from the table in reverse order. In some embodiments, a patch is a 2-D surface that can be drawn to create a 3-D shape.

Use of the edge cache table can potentially avoid use of computationally heavy shader instances, texture look-ups, and filtering. Use of the table can potentially reduce redundant vertex processing and texture look-ups along the edges shared by two or more geometrically contiguous patches.

Current known methods propose processing one patch at a time to exploit parallelism and allow the repeated evaluations of vertices along the edges. This poses a risk or introducing cracks due to a non-commutative nature of floating point arithmetic. To attempt to achieve watertight surfaces, Microsoft® DirectX 11 specifies evaluating domain locations in fixed point arithmetic. To attempt use of parallelism on graphics processing units, various embodiments provide that edge vertices can be evaluated and displaced multiple times and can potentially achieve water-tightness along the edges. Accordingly, various embodiments may reduce evaluation of vertices along shared edges by approximately 50%.

Various embodiments can be incorporated into a DirectX 11 tessellation driver, but can also used in other types of graphics pipelines. Edge-cache tables described herein can be used in any REYES style micro-polygon based pipeline.

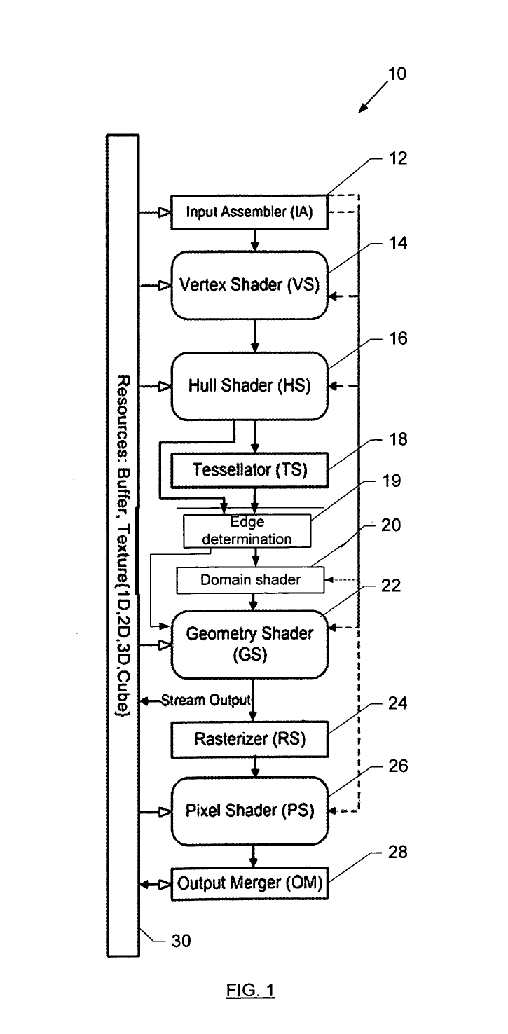

FIG. 1 depicts a graphics pipeline. The graphics pipeline may be implemented in a graphics processor as a standalone, dedicated integrated circuit, in software, through software implemented general purpose processors or by combinations of software and hardware. In some embodiments, in FIG. 1, the elements with right angle edges can be implemented in hardware and the elements with rounded edges can be implemented in software.

The graphics pipeline may be implemented for example in a wireless telephone, a mobile hand-held computing device which incorporates a wired or wireless communication device, or any computer. The graphics pipeline may provide images or video for display to a display device. Various techniques can be used to process images provided to a display. For example, High-Definition Multimedia Interface, DisplayPort, wireless HDMI, and/or wireless HD compliant techniques can be used to transfer images to a display.

Input assembler 12 reads vertices out of memory using fixed function operations, forming geometry, and creating pipeline work items. Auto generated identifiers enable identifier-specific processing, as indicated on the dotted line on the right in FIG. 1. Vertex identifiers and instance identifiers are available from the vertex shader 14 onward. Primitive identifiers are available from the hull shader 16 onward. The control point identifiers are available in the hull shader 16.

The vertex shader 14 performs operations such as transformation, skinning, or lighting. It may input one vertex and output one vertex. In the control point phase, invoked per output control point and each identified by a control point identifier, the vertex shader has the ability to read all input control points for a patch independent from output number. The hull shader 16 outputs the control point per invocation. The aggregate output is a shared input to the next hull shader phase and to the domain shader 20. Patch constant phases may be invoked once per patch with shared read input of all input and output control points. The hull shader 16 outputs edge tessellation factors and other patch constant data. As used herein, edge tessellation factor and edge level of detail with a number of intervals per edge of the primitive domain may be used interchangeably. Codes are segmented so that independent work can be done with parallel finishing with a join step at the end.

The tessellator 18 may be implemented in hardware or in software. In some advantageous embodiments, the tessellator may be a software implemented tessellator. Tessellator 18 is to retrieve encoded domain points or (u,v) values. Stored encoded domain points may be in unsigned integer format. The tessellator 18 may receive, from the hull shader, numbers defining how much to tessellate. Tessellator 18 generates topologies, such as points, lines, or triangles. Tessellator 18 may output at least one vertex.

Edge determination block 19 is to determine whether an evaluated patch A shares an edge with another patch, patch B. If an edge is shared with patch B, then a unique identifier is created in a table for the shared edge. The unique identifier can be a numerical value or other alpha-numeric code. The entry stores numerical attributes of vertices of the shared edge. Domain shader 20 can be used to generate the numerical attributes for the shared edge. When patch B is evaluated (after patch A), a common edge with patch A can be identified. Based on the common edge, the unique identifier can be determined. An entry in the table can be retrieved based on the unique identifier. Numerical attributes for patch B can be retrieved in reverse order instead of calculating those values using domain shader 20. The retrieved numerical values for patch B can be transferred to geometry shader (GS) 22. Accordingly, when evaluating patch B, use of domain shader 20 to determine attributes of an edge shared between patches A and B can be avoided. Edge determination block 19 may request that the table be stored in a cache or other memory (not depicted).

Domain shader 20 is a programmable stage that uses the domain points, (u,v) values, supplied by tessellator 18 to generate a real 3D point on a patch. Domain shader 20 evaluates vertex positions and attributes and displaces the points by looking up displacement maps. Domain shader 20 evaluates a position's normal and other attributes using (u,v) values from tessellator 18. High frequency detail of the patch can be added using a displacement map. In some embodiments, domain shader 20 may be software implemented. In some embodiments, a shader compiler generated portion of domain shader 20 applies scale and bias techniques to convert encoded domain points from tessellator 18 to the domain of [0,1].

Domain shader 20 may displace the point using a scalar displacement map or calculate other vertex attributes. In some cases, vertex evaluations can involve:
1. Determination of a bi-cubic polynomial for positions.
2. Calculating partial derivatives or evaluating the tangent and bi-tangent using auxiliary tangent and bi-tangent control cages and taking their cross products.
3. Performing a texture look-up with some filtering, e.g., linear filtering.
4. Displacing the point along the normal (in case of scalar valued displacements).
5. Displacing the point along the directions that can potentially be read from other texture reads (in case of vector valued displacements).

Geometry shader 22 may input one primitive and output up to four streams, each independently receiving zero or more primitives. A stream arising at the output of the geometry shader can provide primitives to rasterizer 24, while up to four streams can be concatenated to buffers 30. Clipping, perspective dividing, view ports, and scissor selection implementation and primitive set up may be implemented by the rasterizer 24.

Pixel shader 26 inputs one pixel and outputs one pixel at the same position or no pixel. The output merger 28 provides fixed function target rendering, blending, depth, and stencil operations.

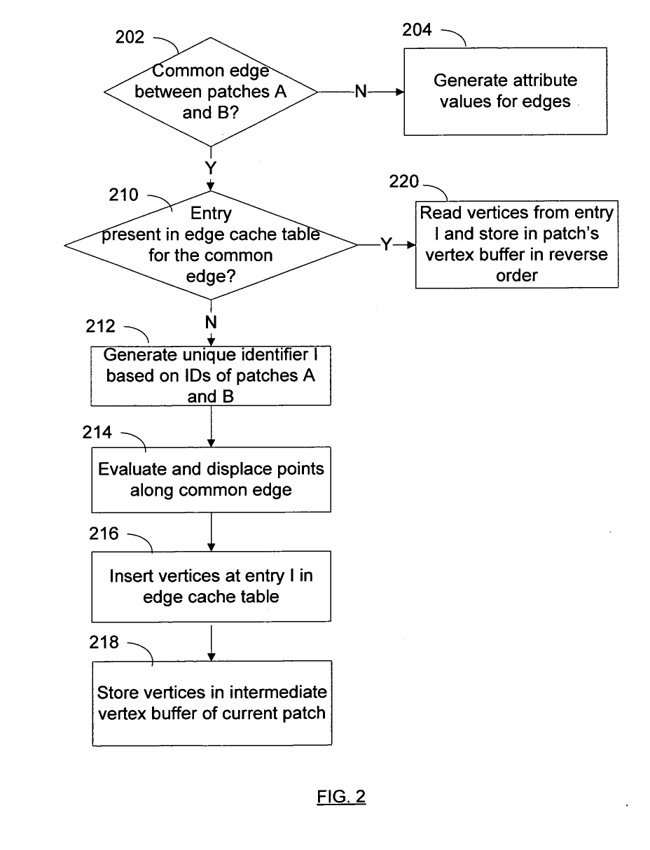

FIG. 2 depicts a process that can be used to determine whether to store or retrieve attributes of a shared edge in a table. Block 202 includes determining whether a patch A has a common edge with another patch, patch B. If there is a common edge, then block 210 follows block 202. If there is no common edge, then block 204 follows block 202. At the time the vertices on this shared edge are evaluated (and displaced) in the context of patch A, the table does not have an entry for the common edge between patches A and B. Processing patch A includes evaluating all points in patch A by using u, v values to create x, y, z values. Processing patch A also includes evaluating points along the edges of patch A shared with other patches. A point in a patch has u, v coordinate. If u or v is 0 or 1, then that point is on edge. In some embodiments, if actual x, y, z positions of end points of an edge of a patch match x, y, z positions of end points of another patch, the edge is shared with another patch.

Block 204 includes generating attribute values for vertices of patch A. A domain shader can be used to generate attribute values. The attribute values can be provided to the geometry shader. This entry is populated after evaluating and displacing all the points along the edge shared between patches A and B. In some embodiments, attribute values can be those described with the table below. The following provides an example of a table.

| | | | Tx- | | |
|---|---|---|---|---|---|
| Index | Positions | Normals | cords | Tangents | Bi-Tgts |
| Hash(PIDA, PIDB) | | | | | |
| Hash(PIDX, PIDY) | | | | | |
| Hash(PIDM, PIDN) | | | | | |

Positions represent positions of the vertices along a shared edge. Normals represents normals of each vertex. Tx-cords represents texture coordinates of each vertex. Tangents represents tangent vectors for each vertex. Bi-tgts represents bi-tangent vectors. Other attributes could be color attributes, transferency, or other user defined attributes. Entries in a table can store all (or some) attributes of the vertices along the shared edge. Each column stores multiple values for each entry, such as multiple position values.

Block 210 includes determining whether an entry for the common edge is present in the edge cache table. If the entry is present, then block 220 follows block 210. If the entry is not present, then block 212 follows block 210. Determining whether an entry for the common edge is present in the edge cache table can be made using a calculation that is a function of the identifiers of patches A and B. For example, the calculation can determine an identifier of an entry based on a hash of the patch numbers for patches A and B because patches A and B share a common edge. When points along an edge shared between patches A and B are to be evaluated in the context of evaluating patch B, the table is evaluated at the location Hash(B,A) to determine if a valid entry is present. Because Hash(B,A) is the same as Hash(A,B), the entry exists and instead of evaluating the points, data stored in the table is retrieved. In addition, the hash assigns entry numbers in a table of a fixed size. For example, if a table is 16 entries, then the hash provides 16 unique identifiers.

For example, for a hash(patchID1, patchID2), where patchID can be maximum 2̂N, where N<=16, a hash operation could be:

unsigned short HashFunc(pid1,pid2)
{

unsigned int smaller = pid1;
unsigned int larger = pid2;
// Use only the last 8 bits of pid-s
smaller &= 0xff;
larger &= 0xff;
if (pid1 > pid2) {

smaller = pid2;
larger = pid1;

}
return ((larger << 8) | smaller); // | is logical OR

}

This hash operation considers the last 8 bits of the two patch identifiers. The larger of the two 8 bit strings is shifted by 8 bits and logically OR'd with the smaller of the two 8 bit strings. The returned value is an unsigned 16 bit value, which is used as an entry identifier I. If two patches have patch identifier values separated by 64, those patches will map to the same entry.

As another example, for a hash(patchID1,patchID2), where patchID can be maximum 2̂ N, where N<=16, a hash operation could be:

unsigned int HashFunc(pid1,pid2)
{

unsigned int smaller = pid1;
unsigned int larger = pid2;
if (pid1 > pid2) {

smaller = pid2;
larger = pid1;

}
return ((larger << N) | smaller); // | is logical OR

}

The returned value, index I, is the larger value is shifted by N bits and then logically OR'd with the smaller value. In this example, N is 16, but N can be other values. When N is 16, the index becomes a 32 bit value and then the table can cover approximately 4 Gbytes of memory. The index I can be subsequently re-mapped to a smaller region of memory.

In some embodiments, a hash operation could minimize contiguous entries in a table to free up space in memory that could be used to store entries to store other information. For example, if there are two entries in a table then the index values could be assigned for two entries in contiguous memory locations. In other scenarios, memory not used to store entries are available for use by other applications. In some cases, entries that are read out in reverse order are available to be over written and the corresponding index value is available to be assigned to another common edge.

Block 220 includes reading vertices from an entry I in the edge cache table in reverse order and storing the vertices into the current patch's vertex buffer. Reading vertices in reverse order takes place because edges are traversed in opposite directions in adjacent patches. For example, if patch B is the current patch and it is determined that attributes of a common edge with patch A are stored in the table, then the attributes for the common edge evaluated with regard to patch A are read out in reverse order.

Block 212 includes generating a unique identifier I for the common edge. A hash calculation can be used to generate the unique identifier I for the common edge based on the patch identification values for patches A and B. Various types of calculations can be performed to determine the unique identifier for an entry in the table. For example, SV_PRIMITIVE_IDs of DirectX 11 represents a patch identification value.

Block 214 includes evaluating and displacing points along the common edge. For example, a scalar displacement map can be used to displace points along a common edge. A domain shader can be used to evaluate and displace points.

Block 216 includes inserting vertices at the entry I in the edge cache table.

Block 218 includes storing vertices in an intermediate vertex buffer for the current patch. Thereafter, the vertex attributes can be used by the geometry shader.

Because some high throughput architectures excel in their computational power more than their memory bandwidth, compute intensive techniques may be favored over the ones that are memory intensive. In this case however, due to long latency of texture units, techniques can be used that rely on memory accesses more than on computations. Various embodiments described herein can be used in Renders Everything You Ever Saw (REYES) style architectures because vertex texturing is more common in those architectures and involve access to more textures than just the displacement maps.

Various embodiments can be used with deferred tessellation techniques to avoid redundant determination of common edges in environments described with regard to Ser. No. 12/347,114, entitled “A TESSELLATOR WHOSE TESSELLATION TIME GROWS LINEARLY WITH THE AMOUNT OF TESSELLATION,” filed Dec. 31, 2008 (attorney docket P29143), inventors Sathe and Rosen; Ser. No. 12/347,114, entitled “IMAGE FORMATION TECHNIQUES,” filed Apr. 29, 2009 (attorney docket P29929), inventors Sathe and Rosen; and PCT/US2009/069353, entitled “Image Processing Techniques,” filed Dec. 23, 2009 (attorney docket P31681).

In a multi-core environment, each core can have its own cache table. For example, a first core generates a cache entry for a shared edge and the first core consumes the cache entry. Because each core deals with a smaller number of patches, a smaller cache can be used than in the situation where a table is shared among multiple cores. If each core uses its own table, entry look ups can be faster. In some cases, edge cache entries can be overwritten after read out for shared edge.

A core can be assigned to perform any type of shader operation such as domain, geometry, or pixel shading. Accordingly, if an entry is retrieved from a table, then a core can be freed from performing domain shading and that freed core can perform other types of operations.

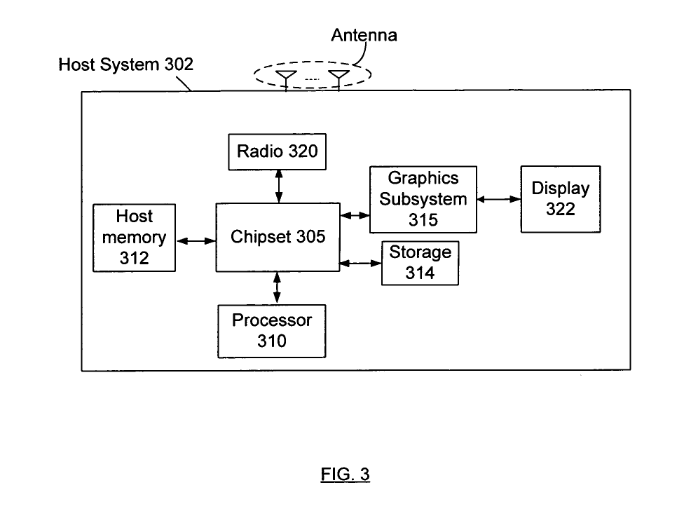

FIG. 3 depicts a suitable system that can use embodiments of the invention. Computer system may include host system 302 and display 322. Computer system 300 can be implemented in a handheld personal computer, mobile telephone, set top box, or any computing device. Host system 302 may include chipset 305, processor 310, host memory 312, storage 314, graphics subsystem 315, and radio 320. Chipset 305 may provide intercommunication among processor 310, host memory 312, storage 314, graphics subsystem 315, and radio 320. For example, chipset 305 may include a storage adapter (not depicted) capable of providing intercommunication with storage 314. For example, the storage adapter may be capable of communicating with storage 314 in conformance with any protocol.

In various embodiments, computer system performs techniques described with regard to FIGS. 1-2 to determine render patches.

Processor 310 may be implemented as Complex Instruction Set Computer (CISC), Reduced Instruction Set Computer (RISC) processors, x86 compatible processors, multi-core, or any other microprocessor or central processing unit.

Host memory 312 may be implemented as a volatile memory device such as but not limited to a Random Access Memory (RAM), Dynamic Random Access Memory (DRAM), or Static RAM (SRAM). Storage 314 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device.

Graphics subsystem 315 may perform processing of images such as still or video for display. An analog or digital interface may be used to communicatively couple graphics subsystem 315 and display 322. For example, the interface may be any of a High-Definition Multimedia Interface, DisplayPort, wireless HDMI, and/or wireless HD compliant techniques. Graphics subsystem 315 could be integrated into processor 310 or chipset 305. Graphics subsystem 315 could be a stand-alone card communicatively coupled to chipset 305.

Radio 320 may include one or more radios capable of transmitting and receiving signals in accordance with applicable wireless standards such as but not limited to any version of IEEE 802.11 and IEEE 802.16.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-readable medium that stores instructions, which when executed by a computer, cause the computer to:
determine whether an edge of a first patch is shared with a second patch;
determine an index for an entry based on identifiers of the first and second patches in response to the edge of the first patch being shared with the second patch; and
store attributes of the shared edge in the entry in a table in response to the edge of the first patch being shared with the second patch.

2. The medium of claim 1, wherein the instructions further comprise instructions, which when executed by a computer, cause the computer to:
determine whether the second patch shares an edge with another patch;
selectively determine a second index based on identifiers of the second patch and the another patch in response to the second patch sharing an edge with the another patch;
request attributes of the edge shared by the second patch and the another patch based on the determined second index; and
provide the requested attributes in reverse order.

3. The medium of claim 1, wherein to determine an index for an entry and to determine a second index both comprise applying a hash operation that provides the same value regardless of whether the identifiers are reversed as inputs to the hash.

4. The medium of claim 1, wherein to determine an index for an entry and to determine a second index both are to:
shift a larger value patch identifier by X bits;
logically OR the shifted patch identifier with the smaller value patch identifier; and
provide the index as the logically OR'd value.

5. The medium of claim 4, wherein X comprises one of 8 or 16.

6. The medium of claim 1, wherein the instructions further comprise instructions, which when executed by a computer, cause the computer to:
request attributes of the edge from a domain shader.

7. The medium of claim 1, wherein the attributes comprise:
positions of vertices along a shared edge, texture coordinates, and normals of each vertex.

8. A system comprising:
a wireless network interface;
a display; and
a computing system to generate patches to transmit to the display, wherein the computing system comprises:
edge analysis logic to:
determine an index for an entry based on identifiers of first and second patches in response to an edge of the first patch being shared with the second patch and
store attributes of the shared edge in the entry in a table in response to an edge of the first patch being shared with the second patch.

9. The system of claim 8, wherein the edge analysis logic is to:
determine whether the second patch shares an edge with another patch;
selectively determine a second index based on identifiers of the second patch and the another patch in response to the second patch sharing an edge with the another patch;
request attributes of the edge shared by the second patch and the another patch based on the determined second index; and
provide the requested attributes to a geometry shader in reverse order.

10. The system of claim 9, wherein to determine an index for an entry and to determine a second index both comprise applying a hash operation that provides the same value regardless of whether the identifiers are reversed as inputs to the hash.

11. The system of claim 9, wherein to determine an index for an entry and to determine a second index, the edge analysis logic is to:
shift a larger value patch identifier by X bits;
logically OR the shifted patch identifier with the smaller value patch identifier; and
providing the index as the logically OR'd value.

12. The system of claim 11, wherein X comprises one of 8 or 16.

13. The system of claim 9, wherein the attributes comprise:
positions of vertices along a shared edge, texture coordinates, and normals of each vertex.

14. A graphics pipeline comprising:
domain shader logic to determine attributes of edges of a patch and store the attributes;
edge determination logic to selectively request the attributes of an edge shared by first and second patches to be provided in reverse order in response to a determination that the first patch shares an edge with a second patch; and
geometry shader logic to receive stored attributes in response to a determination that the first patch shares an edge with the second patch.

15. The graphics pipeline of claim 14, wherein the domain shader logic is to store attributes of an edge of a patch in a table in response to the edge being shared with another patch.

16. The graphics pipeline of claim 14, wherein the edge determination logic is to determine an identifier of the requested attributes based on identifiers of the first and second patches irrespective of an order in which the identifiers of the first and second patches are received.

17. The graphics pipeline of claim 16, wherein patch identifiers comprise SV_PRIMITIVE_IDs of DirectX11.

18. The graphics pipeline of claim 14, wherein to determine an identifier of the requested attributes, the edge determination logic is to:
shift a larger value patch identifier by X bits;
logically OR the shifted patch identifier with the smaller value patch identifier; and
provide the index as the logically OR'd value, wherein X comprises one of 8 or 16.

19. The graphics pipeline of claim 14, wherein the attributes comprise:
positions of vertices along a shared edge, texture coordinates, and normals of each vertex.

20. The graphics pipeline of claim 14, further comprising a table to store attributes of each shared edge.
